(19) United States
(12) Patent Application Publication
(10) Pub. No.: US 2009/0288359 A1
(43) Pub. Date: Nov. 26, 2009

(54) Polyvinyl Chloride (PVC) Compositions and Reinforced Flexible PVC Flooring With Improved Performance Formed of the Same

(76) Inventors: Joel E. Martin, JR., Charlotte, NC (US); Richard C. Neale, III, Roswell, GA (US); Robert J. Schiavone, Matthews, NC (US); Marion L. Andrews, Darlington, SC (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 11/951,436

(22) Filed: Dec. 6, 2007

Related U.S. Application Data
(60) Provisional application No. 60/942,488, filed on Jun. 7, 2007.

(51) Int. Cl. E04C 2/20; C08L 27/06; C08K 5/09; C08K 5/092; C08K 5/51; C08L 1/00; B32B 27/04; B32B 5/02

(52) U.S. Cl. 52/309.1; 524/569; 524/321; 524/287; 524/147; 524/35; 428/297.4; 428/220

(57) ABSTRACT

Polyvinyl chloride (PVC) compositions including PVC; fibrous material; and a primary plasticizer component including a low extractable plasticizer are disclosed. The compositions can be useful in the production of flooring products that exhibit improved plasticizer hydrocarbon extraction resistance.

### CROSS-REFERENCE TO RELATED APPLICATIONS

This application claims priority under 35 USC Section 119(e) from provisional application Ser. No. 60/942,488, filed Jun. 7, 2007, for “Reinforced Flexible PVC Flooring with Improved Performance,” which is hereby incorporated by reference in its entirety.

### FIELD OF THE INVENTION

The present invention relates to polymeric compositions which can be useful in the production of flooring materials, including polymer-based flooring materials for “non-skid” applications, sanitary applications, and applications in which both non-skid and sanitary characteristics may be desired or necessary. The present invention also relates to polymeric flooring materials and methods for making polymeric sheet materials.

### BACKGROUND OF THE INVENTION

Certain structural elements in commercial or other public establishments must meet the requirements of various local, state or federal codes. For example, a restaurant is typically governed by local health and sanitation codes, and if it meets certain other criteria, may also be subject to state and federal health and safety requirements such the Occupational Health and Safety Act (29 U.S.C. § 651 et seq.) and related regulations such as (but not limited to) 29 CFR 1910.21-1910.30.

In most circumstances, a restaurant must be floored with a material that can be maintained at, or if necessary brought to, the highest sanitary standards. Additionally, restaurant flooring, particularly kitchen (or other food handling and preparation areas), should be formed of a material that helps prevent workers from slipping when the floor is wet or otherwise soiled with food or food preparation materials.

The concurrent requirements for high standards of sanitation and non-slip (non-skid) characteristics can be at odds with one another in certain structures. For example, some non-slip surfaces are prepared by mixing a polymer or paint with a solid (grit) material and applying the polymer in a manner analogous to painting to produce a surface with embedded abrasive particles. Non-slip flooring is also often produced by forming a three-dimensional pattern in the flooring material itself.

Alternatively, surfaces intended for sanitary use are often preferably as smooth as possible so that they can be easily cleaned on a frequent basis and so that they avoid structural elements that can trap dirt or other undesired items that can contribute to unsanitary conditions.

Typical materials for commercial kitchen flooring (although certainly applicable to residential areas as well) have included wood, concrete or cement, and ceramic and non-ceramic tile. Each of these offers certain advantages and disadvantages depending upon the particular circumstances.

More recently, polymer materials have been used for these applications. As in many other circumstances, polymers are (usually) low in relative cost as compared to wood or ceramic tile, are widely available and offer a range of desirable properties.

Some of these polymer materials are available in pre-cured form, typically liquids. They are then applied using brushes, rollers or squeegee-type tools. Such pre-cured polymers can be applied to a wide variety of surfaces and because of their liquid form, need not be precut or otherwise dimensioned because they (like all liquids) simply take the shape of their container, which in this case is the floor.

As potential disadvantages, however, materials applied as liquids typically require a finite drying time, may produce undesired (or even regulated) solvent vapors, may not stick well to certain underlying surfaces and may require sophisticated priming or be limited to certain surface materials.

Other polymers are available in cured sheets that can simply be positioned as desired all on a floor to be covered. For example, certain vinyl (e.g. polyvinyl chloride or “PVC”) polymers can be manufactured into sheets or rolls for use as flooring in commercial and sanitary applications such as commercial kitchens, restaurants, hospitals, and the like. Examples of commercially available materials are sold under the Protect-All® name by Oscoda Plastics, Inc. The Protect-All® products are produced from post-industrial vinyl with a major recycle component being scrap roofing membrane from a PVC roofing system available from Duro-Last, Inc.

Roofing materials, including PVC roofing membranes, are subject to high temperatures during processing and installation. Such products are also subject to variances in temperatures, humidity and other environmental conditions after installation, and a roof can expand and contract in any and all directions due to varying environmental conditions. Roofing products should exhibit suitable flexibility even when exposed to extremes of low and high temperatures or the product can fail. Low temperature performance in particular can be essential to prevent embrittlement and cracking of a PVC roofing membrane.

PVC used in the production of PVC roofing materials accordingly is typically combined with a suitable plasticizer to facilitate processing and to protect the product following installation, i.e., to provide the requisite flexibility to the PVC product to avoid cracking and failure of the roofing system upon repeated exposure to temperature extremes. As an example, U.S. Pat. No. 4,358,499, directed to PVC roofing membrane compositions, discusses the use of alkyl phthalates such as octyl, nonyl, decyl and mixed dialkyl phthalates for the best outdoor performance. PVC roofing membranes made using these plasticizers are stated to have less than 1.5% shrinkage when held at 176° F. (80° C.) and yet remain flexible at −60° F. (−51° C.). PVC roofing membranes will typically include monomeric low molecular weight plasticizers of the type exemplified by the '499 patent so that the roofing membrane will exhibit suitable high and low service temperatures to withstand the extremes in temperature that the membrane can experience during its lifetime. In contrast, polymeric plasticizers generally exhibit poor low temperature performance and thus typically are not used in flexible roofing applications.

Flooring systems produced using recycled PVC roofing membrane materials can offer several benefits, such as a comfortable, seamless, and non-slip floor covering that can provide cushioning surfaces (important to those who work on their feet for extended periods of time), that can be easily cleaned and maintained at the necessary sanitary standards, and that provide a greater grip in many circumstances than materials such as wood or ceramic tile. Despite the benefits of such flooring systems, however, flexible PVC flooring sheets produced using recycled PVC roofing membrane, such as the Protect-All® product, can become brittle in less than three years after being placed in service. The flooring systems can also shrink, which can place stress on the sheet and welds and result in cracking, curling, distortion and separation from the floor bond. This in turn can result in a workplace hazard as well as unsanitary conditions due to the entrapment of dirt, food, and other undesired items. The flooring systems can also exhibit a loss of the cushioning and non-slip characteristics.

### SUMMARY OF THE INVENTION

In one aspect, the present invention is directed to polymeric compositions that can be useful for the production of flooring materials for sanitary and/or non-skid applications, such as commercial kitchens, restaurants, hospitals, and the like. The polymeric compositions of the invention include polyvinyl chloride (PVC); fibrous material; and a primary plasticizer component. The plasticizer component includes a low extractable plasticizer, such as a polymeric plasticizer or a monomeric plasticizer that strongly interacts with PVC. The low extractable plasticizer can be present in an amount selected to minimize hydrocarbon extraction of the primary plasticizer component from a sheet material formed of the composition. In exemplary embodiments of the invention, the plasticizer component can include the low extractable plasticizer in an amount of about 45 to about 100 percent, for example about 45 and about 70 percent, of the low extractable plasticizer.

The inventors have determined that recycled scrap roofing membrane such as that used in the production of the Protect-All® product can include low molecular weight plasticizers such as hexyl, octyl, nonyl, and decyl phthalates, presumably to provide the requisite flexibility and performance required for roofing products exposed to extremes of temperature and other environmental conditions. See Examples 1 and 2 below, which set forth the results of an analysis of a roofing membrane and a commercial flooring product.

Although not wishing to be bound by any explanation or theory of the invention, it is currently believed that these phthalate plasticizers and other low molecular weight plasticizers, although necessary for the performance of roofing materials, are also capable of being extracted by non-polar solvents and oils. The inventors were the first to appreciate that flooring products produced using such recycled PVC roofing membranes in commercial kitchens or other demanding environments can suffer an embrittlement defect due to significant exposure of the flooring to greases, oils or other hydrocarbons, which can extract the phthalate plasticizers and other low molecular weight plasticizers that were originally part of the roofing membrane or other plasticizer added during manufacture of the flooring.

Accordingly, in another aspect, the present invention is directed to a floor covering that can be installed as welded, seamless floors for various commercial and/or sanitary applications, such as restaurants, commercial kitchens, hospital operating rooms, and the like. The floor covering can have resistance to plasticizer extraction by hydrocarbons, such as cooking oils, grease, petroleum based oils and solvents, as well as cleaning products. Thus, the flooring of the invention can exhibit minimal or substantially no embrittlement defects. As a result, the flooring of the invention can exhibit improved cushioning properties and non-skid performance. The flooring of the invention can also exhibit reduced shrinkage, which in turn can improve the sanitary performance of the flooring. Accordingly, in commercial and sanitary flooring applications, the flooring can substantially maintain its non-slip, sanitary performance and flexibility through out its lifetime, which can be up to 10 years or longer.

In this aspect of the invention, the floor covering can be formed of a sheet of polymer material comprising polyvinyl chloride; fibrous material; and a primary plasticizer component comprising a low extractable plasticizer in an amount sufficient to substantially minimize hydrocarbon extraction of the primary plasticizer component from the floor covering. The floor covering can have a thickness of about ⅛ to about ¼ inch. Following exposure to hydrocarbons such as cooking oils and grease, floor coverings about ¼ inch thick may further have a hydrocarbon extractability of the plasticizer component of less than about 3.5 percent; a Shore A hardness of less than about 90, as measured by ASTM D2240; and a Shore D hardness of less than about 41, as measured by ASTM D2240.

Other aspects of the invention can include a flooring element comprising a generally rectangular three-dimensional solid polymer in a thickness of about ⅛ to about ¼ inch, a width of at least about four feet and a length of at least about six feet comprising polyvinyl chloride; fibrous material; and a primary plasticizer component comprising a low extractable plasticizer in an amount sufficient to substantially minimize hydrocarbon extraction of the primary plasticizer component from the flooring element.

Still further the invention can include methods of making a polymeric sheet material useful for the production of sanitary non-skid flooring. This aspect of the invention can include mixing polyvinyl chloride (PVC), fibrous material, and a primary plasticizer component to form a PVC composition, wherein the primary plasticizer component comprises a low extractable plasticizer in an amount sufficient to substantially minimize hydrocarbon extraction of the primary plasticizer component from a sheet material formed of the composition. The method can further include forming a sheet material having a thickness of about ⅛ to about ¼ inch from the composition.

In various embodiments of the method of the invention, the mixing step can include dispersing PVC in a liquid plasticizer component to form a plastisol, thereafter mixing the fibrous material in the plastisol, and the forming step can include molding the plastisol to form the sheet material. In other embodiments of the method of the invention, the mixing step can include dry blending the PVC, fibrous material and primary plasticizer component, and the forming step can include melt extruding the dry blend. In this embodiment of the invention, the dry blend can be pelletized to form pellets prior to the melt extruding step. Also in this embodiment of the invention, recycled PVC can be melt blended with the dry blend, which can be in the form of pellets, prior to melt extrusion.

The foregoing and other advantages of the invention and the manner in which the same are accomplished will become clearer based on the followed detailed description taken in conjunction with the accompanying drawings.

### BRIEF DESCRIPTION OF THE DRAWINGS

Having thus described the invention in general terms, reference will now be made to the accompanying drawings, which are not necessarily drawn to scale, and wherein:

FIG. 1 is a graph illustrating the relationship between Shore “D” hardness and loss of plasticizer from 0.25″ thick plaques from PVC flooring; and

FIG. 2 is a graph illustrating the linear relationship between plasticizer losses for 0.25″ plaque and 20 mil films.

### DETAILED DESCRIPTION OF THE INVENTION

The present invention now will be described more fully hereinafter in the following detailed description of the invention with reference to the accompanying drawings, in which some, but not all embodiments of the invention are described. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, and “the” include plural referents unless the context clearly dictates otherwise.

The polymeric compositions of the invention can include a polyvinyl chloride (PVC) polymer, a fibrous material, which can act as a reinforcing and/or cushioning component, and a primary plasticizer component that in turn includes a low extractable plasticizer. The compositions of the invention can also optionally include other components suitable for the processing and performance of sanitary flooring applications, such as but not limited to heat stabilizers, secondary heat stabilizers/plasticizers, pigments, fillers, mildewcides, UV and light stabilizers, antioxidants, flame retardants and the like as well as combinations thereof.

Any of the types of PVC resins known in the art can be useful as a component of the compositions of the invention. The PVC resin may be in the form of a plastisol or dry blend. Further, the compositions of the invention can include virgin PVC, recycled PVC, such as PVC recycled from various roofing products, and combinations of virgin and recycled PVC. The relative amount of virgin and recycled PVC is not critical in the present invention, so long as the composition includes a primary plasticizer component with a low extractable plasticizer as described in more detail herein.

As a non-limiting example, PVC homopolymers with inherent viscosities measured by ASTM-D-1243-60-A ranging from about 0.63 to about 1.60 dl/g, or more, for example, about 0.78 to about 1.40 dl/g, for example, about 0.83 to about 1.40 dl/g, can be useful for production of the flexible flooring. PVC homopolymers are typically used, although PVC copolymers can also be useful in part or in total as the polymeric material for the flooring composition. Typical copolymers can include without limitation vinyl chloride-vinyl acetate copolymers, vinyl chloride-vinylidene chloride copolymers, vinyl chloride maleate and fumarate copolymers, vinyl chloride-olefin copolymers, vinyl chloride-acrylonitrile copolymers, and the like, and combinations thereof.

The polymeric compositions of the invention further include a primary plasticizer component, which includes a low extractable plasticizer. As discussed herein, the inventors were the first to appreciate that the extraction resistance requirements of reinforced, flexible PVC safety flooring for commercial and sanitary applications are not being met by current flexible PVC commercial flooring products on the market today. As also discussed herein, the present inventors were the first to appreciate that the performance failure of such PVC flooring was due at least in part to hydrocarbon extraction of low molecular weight, highly hydrocarbon extractable plasticizers commonly used in PVC roofing membrane materials. The inventors were the first to understand that such highly extractable plasticizers could be replaced with low extractable plasticizers to improve the cushioning, shrinkage and anti-skid properties of such flooring products, yet without significant adverse affect on the flexibility of the flooring.

As used herein, the term “low extractable plasticizer” refers to a plasticizer that exhibits extraction resistance from a flooring article including the same as a component when exposed to hydrocarbons such as cooking oils, grease, petroleum based oils and solvents, as well as cleaning products. Extraction resistance can be determined as discussed in more detail below.

As an example, for restaurant and other commercial kitchen flooring applications in which the floor comes into repeated contact with cooking oil and grease, the extractability of the primary plasticizer component can be less than about 3.5 percent by weight of the total weight of the primary plasticizer component for a one-quarter inch thick flexible PVC floor. In this manner, the flooring may maintain the integrity and safety characteristics thereof. Because the extraction of plasticizer by cooking oil or grease is a surface phenomenon that occurs within the first few mils (one-thousandth of an inch) that occurs through repeated contact of the extractant followed by cleaning, the flexible PVC flooring resistance to extraction can be predicted by the extraction of 20 mil films as described below using the accelerated extraction test as set forth in more detail in Examples 4a-h. In this regard, the primary plasticizer extraction from a 20 mil film using this test method can be less than 25 weight percent of the plasticizer in the 20 mil film.

Exemplary low extractable plasticizers useful in the present invention can include high molecular weight plasticizers, for example, polymeric plasticizers such as those produced from multi-functional acids and alcohols with molecular weights in the range of about 500 to about 7000 Daltons. Polymeric plasticizers can be linear or branched polymers. Polymeric plasticizers can be based on adipic acid, glutaric acid, sebacic acid, azelaic acid, and the like, and combinations thereof. Exemplary polymeric plasticizers useful in the present invention include without limitation those produced by CP Hall under the trade names Paraplex® and Plasthall® and BASF under the trade name Palamoll®.

Although polymeric plasticizers generally can have greater extraction resistance than monomeric plasticizers, the invention is not limited to polymeric plasticizers. Monomeric plasticizers that strongly interact with PVC can also be useful as the low extractable plasticizer. A non-limiting example of a low extractable monomeric plasticizer useful in the present invention is butyl benzyl phthalate coester, which can impart extraction resistance due to its strong salvation in PVC.

To achieve suitable extraction resistance performance, the primary plasticizer component can include about 45 to about 100 percent, for example about 45 and about 70 percent, of the low extractable plasticizer. In yet another embodiment of the invention, the primary plasticizer component can include about 60 to about 46 percent of the low extractable plasticizer.

The primary plasticizer component can further include a plasticizer which does not meet the criteria described herein for a “low extractable” plasticizer, such as various monomeric plasticizers that do not exhibit a strong affinity for PVC resins. Examples of monomeric plasticizers include many mono-, di-, and tri-esters of mono-, di-, tri-carboxylic acids and phosphoric acid, such as phthalates, i.e., dioctyl phthalate, adipates, i.e., dioctyl adipate, trimellitates, i.e., trioctyl trimellitate, and the like, and combinations thereof.

In various embodiments of the invention, the primary plasticizer component can accordingly include such additional non-low extractable plasticizers in an amount of about 0 to about 55 percent, for example about 30 to about 55 percent. Surprisingly, the inventors have found that the primary plasticizer can include a highly extractable plasticizer component such as a low molecular weight monomeric plasticizer and still maintain the desired performance and properties of the flooring.

The flooring material can also include a reinforcing fibrous material, which, when added to the PVC resin, can add strength, cushioning, and the like to flooring articles produced using the polymeric composition. The reinforcing fibrous component can be in any of the various fibrous forms useful for reinforcing and strengthening a polymeric product, such as but not limited to fibers, filaments, yarns, rovings, chopped strands, and woven and nonwoven fabrics, and the like, as well as combinations thereof. The composition can include the fibrous materials in an amount of about 10 to about 30 weight percent, for example, about 10 to about 25 weight percent.

The fibrous material can be formed of any material suitable for the formation of a particular fibrous article, i.e., can be any of the types of polymer resins, including synthetic or natural polymers) known in the art capable of being formed into fibrous materials. Examples of synthetic polymers useful in the practice of the present invention include without limitation polyesters, including polyethylene terephthalate (PET), polyethylene naphthalate (PEN), polytrimethylene terephthalate (PTT), poly(1,4-cyclohexylene dimethylene terephthalate) (PCT), and aliphatic polyesters such as polylactic acid (PLA); polyamides, including nylon 6 and nylon 6,6; polyolefins, including polypropylene, polyethylene, polybutene, and polymethyl pentene; acrylics; cellulose based materials such as cellulose acetate; and the like, as well as co- and ter-polymers of these and other suitable polymers, and combinations thereof. Other exemplary fibrous materials include without limitation fiberglass, carbon fibers, mineral fibers, such as Wollastanite fibers, and the like, and combinations thereof. The fibrous material can also include natural fibrous materials, such as cotton fibers, wool fibers, and the like, as well as combinations thereof.

Heat set staple polyester fibers with a denier per fiber (dpf) in the range of about 0.5 to about 13 can be useful, for example, heat set staple polyester fibers with a dpf of about 3 to about 6. Staple polyester fibers having a cut length of about one-eighth to about one-half of an inch can also be useful. A heat set, un-crimped polyester fiber with an inherent viscosity of 0.61 (ASTM D4603-03) and a one-eighth inch (⅛″) cut length is available from the Barnet Company. Nylon fibers can also be useful as reinforcements for flexible PVC, for example, nylon 6 fibers with a dpf of about 3 to about 6 and nylon 66 fibers with a dpf of about 1 to about 22.

During the processing of PVC in the melt state at elevated temperatures, PVC tends to degrade and forming “polyenes” in polymer chain backbone through an unzipping mechanism involving release of hydrogen chloride. The polyenes further react to create color bodies in PVC. Accordingly, it can be useful to include heat stabilizers in the compositions of the invention to block the dehydrochlorination and unzipping reaction. Heat stabilizers can also react with hydrochloric acid. Exemplary heat stabilizers useful in the invention can include mixed metal stabilizers such as barium-zinc compounds, cadmium-barium-zinc compounds, lead compounds, tin compounds, calcium-zinc compounds, and the like, and combinations thereof, which can function as primary heat stabilizers. Other exemplary heat stabilizers useful in the invention can include epoxy compounds such as epoxidized soybean oil, which can function as secondary heat stabilizers as well as secondary (non-low extractable) plasticizers. Barium-zinc mix metal stabilizer is available from Chemtura Corporation under the trade name Mark 4878 and an epoxidized soybean oil is available from Chemtura under the trade name Drapex 6.8. Heat stabilizers can be generally used in the range of about 1 to about 5 parts per hundred parts of PVC.

Flexible PVC recipes and formulations can contain other additives such as pigments, fillers, antimicrobials, mildewcides, UV and light stabilizers, antioxidants, flame retardants, and the like, and combinations thereof.

The PVC compositions of the invention can be prepared using various techniques, and the resultant compositions can be formed into a sheet material suitable for use in the production of flooring materials. Exemplary processes for the production of PVC compositions and sheet materials in accordance with the present invention are described below. The skilled artisan will appreciate, however, that the invention is not limited to these methods.

As noted herein, the PVC can be used in the form of a plastisol. Plastisols can be produced by dispersion of PVC resins with particle sizes in the range of about 1 to about 2 microns in liquid plasticizers. Other additives, heat stabilizers, pigments, fillers, antimicrobials, mildewcides, UV and light stabilizers, antioxidants, flame retardants, and the like, and combinations thereof can be added to the plastisol. Plastisol dispersions can be produced with paddle type mixers that allow control over shear and reduce shear heating. Plastisols are typically fused at about 350 to about 375° F. to produce a homogenous mass. The plastisol can be mixed with the fibrous material, and the resultant composition can be molded to form a sheet material using any suitable technique, such as slush molding, rotational molding, dip molding, cavity molding, and the like.

PVC dry blends can also be used to prepare PVC and plasticizer compounds in which the plasticizer is absorbed on porous PVC particles with a large surface area. This can allow production of plasticized PVC at lower temperature with higher quality. PVC dry blends can be produced with the use of jacketed internal mixers such as ribbon mixers, tumble blenders, dough type mixers, and Muller type mixers. High intensity mixers, such as a Reimelt-Henschel mixer, in which heat is generated by particle to particle friction at high shear can also be used to produce PVC dry blends. Due to heat generation, no external heating is necessary when a high intensity mixer is used. For the preparation of dry blends, the PVC powder sorptive resins can be added to the mixer and the PVC can be heated to between about 175 to about 220° F. Plasticizers can be added typically over a time period of about 10 to about 20 minutes. The plasticizer can be pre-heated to increase the rate of sorption with the PVC particles. The plasticizer addition can be followed by addition of heat stabilizers, colorants, and other suitable additives, which can be dispersed in plasticizers. Dry pigments, fillers and other ingredients can then be added and the mixture can be allowed to “dry up”. Lubricant can be added as the last ingredient and the blend can be cooled to less than about 140° F. PVC additives such as heat stabilizers, pigments, fillers, antimicrobials, mildewcides, UV and light stabilizers, antioxidants, flame retardants, and the like, and combinations thereof can be used in dry blends.

As a non-limiting example, a fiber reinforced flexible PVC sheet composition can be prepared from dry blended polymeric plasticizers, Oxyvinyl 240F PVC, heat stabilizers, polyester fiber (⅛ inch cut), and lubricant, such as exemplified in Example 5, Table VI, discussed in more detail below.

The dry blend can be directly melt extruded to form a polymeric sheet material. Alternatively, the dry blend can be melt extruded and pelletized using conventional techniques, and the pellets subsequently melt extruded to form a polymeric sheet material.

Also as noted herein, the PVC resin can be virgin PVC, recycled PVC resin, or a combination of virgin and recycled PVC resin. In exemplary embodiments of the invention, recycled PVC resin, such as PVC resin recovered from recycled PVC roofing materials, can be mixed with the composition of the invention prior to forming the polymeric sheet material. As a non-limiting example, for applications using a PVC dry blend, the PVC dry blend can be prepared as described herein and pelletized. Thereafter the recycled PVC resin can be blended with the pellets, for example melt blended in an extruder, prior to extrusion of the resultant composition to form a polymeric sheet material.

The compositions can be used in the production of flooring for various applications, including without limitation sanitary non-skid flooring such as found in restaurants and other commercial kitchens. The present invention is not so limited, however, and the compositions can also be useful for the production of flooring for use in other environments, particularly environments in which a non-skid, sanitary and/or cushioned flooring would be useful, such as hospitals, including operating rooms, and the like. Exemplary techniques for the production and installation of such flooring can be found in copending U.S. application Ser. Nos. 11/456,747, filed Jul. 11, 2006, and 11/776,314, filed Jul. 11, 2007, the entire disclosure of each of which is hereby incorporated by reference.

Shore “A” and “D” Durometer testing according to ASTM D2240 can be used to determine flexibility of the PVC flooring compositions before and after extraction to determine the percentage of plasticizer that could be extracted from the floor and still function as a flexible non-slip safety floor. To maintain the flexibility and safety characteristics of the floor, the Shore “A” hardness can be less than or about a reading of 90 on the Type “A” durometer scale, and in exemplary embodiments the flooring can exhibit a Shore A hardness ranging from about 80 to about 90, for example for about 83 to about 90, and as another example from about 85 to about 90. Also to maintain the flexibility and safety characteristics of the floor, Shore “D” hardness should be less than or about a reading of 41 on the Type “D” durometer scale, and in exemplary embodiments, the flooring can exhibit a Shore D hardness of about 31 to about 41, for example from about 33 to about 41, and as another example from about 36 to about 41.

The present invention may be better understood by reference to the following examples that are intended for the purpose of illustration and are not to be construed as in any way limiting the scope of the present invention, which is defined in the claims appended hereto.

### Example 1

Roofing membrane scrap is separated into components by first dissolving the PVC envelope from the polyester tricot fabric. The roofing membrane, 29.64 grams, is placed in a one-liter Erlenmeyer flask containing 300 milliliters of tetrahydrofuran (THF) at room temperature. After the PVC envelope dissolves away from the polyester tricot fabric, the tricot is removed from the THF suspension and washed with THF. The tricot fabric weighs 4.51 grams after drying which is 15.22% of total roofing membrane. The THF suspension of PVC envelope plus its additives are centrifuged. The liquid layer is decanted from the solids, and the solids are dispersed in THF and centrifuged again to remove any remaining PVC solution from the solids. The THF is evaporated from the solids, and after drying the solids weigh 2.62 grams which is 8.84 percent of total roofing membrane. The decanted PVC solution which contains plasticizer and other additives such as titanium dioxide is dried and the dried PVC film weighs 21.94 grams which is 74.02 percent of total roofing membrane.

A sample weighing 9.74 is cut from the dried PVC film. This film is extracted with diethyl ether (ether) and the remaining insoluble portion of the film is removed from the ether and washed with ether. The ether is evaporated from the extract to give liquid plasticizer that weighs 3.19 grams. The liquid extract is analyzed by gas chromatograph-mass spectrometry (GCMS). It is found to be composed of phthalate ester. The major peaks in the GC are identified as phthalate esters of linear and branched C7, C9, and C11 alcohols. The peaks are of linear and branched C7, C9, and C11 phthalate esters that are based on 1-heptanol, 2-methyl-1-hexanol, 1-nonanol, 2-methyl-1-octanol, 1-undecanol, and 2-methyl-1-decanol.

### Example 2

A sample of a commercial floor covering is analyzed in a similar way to the roofing membrane as in Example 1. In particular, a sample of a commercial floor covering 30.32 grams is separated into components by first dissolving the PVC from the fiber and additives in the flooring. The floor covering, 30.32 grams, is placed in a one-liter Erlenmeyer flask containing 300 milliliters of tetrahydrofuran (THF) at room temperature. After the PVC is dissolved away from the polyester fiber leaving fiber mat, the fiber is removed from the THF suspension by filtration and washed with THF. The fiber mat weighs 3.31 grams after drying which is 11.84% of total flooring. The THF suspension of PVC plus its additives is centrifuged. The liquid layer is decanted from the solids, and the solids are dispersed in THF and centrifuged again to remove any remaining PVC solution from the solids. The THF is evaporated from the solids, and after drying the solids weigh 1.60 grams which is 5.28 percent of total flooring. The decanted PVC solution which contained plasticizer and other additives such as titanium dioxide is dried and the dried PVC film weighs 24.63 grams which is 81.23 percent of total flooring.

A sample weighing 9.65 is cut from the dried PVC film. This film is extracted with diethyl ether (ether) and the remaining insoluble portion of the film is removed from the ether and washed with ether. The ether is evaporated from the extract to give liquid plasticizer that weighs 3.33 grams. The liquid extract is analyzed by gas chromatograph-mass spectrometry (GCMS). It is found to be composed of phthalate ester and adipate ester. The major peaks in the GC are identified as dioctyl adipate (bis(2-ethylhexyl) adipate) and phthalate esters of linear and branched C7, C9, and C11 alcohols. The peaks are of linear and branched C7, C9, and C11 phthalate esters that appear to be based on 1-heptanol, 2-methyl-1-hexanol, 1-nonanol, 2-methyl-1-octanol, 1-undecanol, and 2-methyl-1-decanol. The floor covering is found to contain the same phthalate plasticizers as the roofing membrane in Example 1. However there is an additional plasticizer, dioctyl adipate, that is not present in the roofing membrane. The liquid extract is also analyzed by nuclear magnetic resonance spectroscopy (NMR) and is found to contain about 20% of bis(2-ethylhexyl) adipate and 80% of the mixed phthalate esters.

### Example 3

The loss of plasticizer is determined for a sample of commercial flooring which was installed in a restaurant kitchen (sanitary application), exposed to cooking oil and grease during a three-year period, and became rigid. Three samples are cut from the rigidified flooring, cut into small pieces, and extracted with diethyl ether at room temperature. The plasticizer content in the rigid flooring is compared to never installed flooring (control) that is extracted in a similar fashion. Table I gives the results of the extraction with ether.

TABLE I
Rigid Flooring and Uninstalled Flooring Extraction with Ether

| | | | | | Percentage |
|---|---|---|---|---|---|
| | Weight | Weight | Weight | Extract | Loss |
| | before | after | of | percentage | Relative to |
| Flooring | extraction | extraction | Extract | of | Uninstalled |
| Samples | (grams) | (grams) | (grams) | Flooring | Floor |
| Rigid | 10.09 | 7.87 | 2.22 | 22.00 | 11.18 |
| Sample 1 | | | | | |
| Rigid | 11.90 | 9.34 | 2.56 | 21.51 | 13.16 |
| Sample 2 | | | | | |
| Rigid | 9.60 | 7.52 | 2.08 | 21.67 | 12.52 |
| Sample 3 | | | | | |
| Uninstalled | 9.97 | 7.50 | 2.47 | 24.77 | — |
| Flooring | | | | | |

The Shore “A” Hardness of the uninstalled flooring is a 87.7 durometer reading with a Type A Durometer and the Shore “A” Hardness of the rigid flooring is >90 reading on a Type “A” Durometer. The rigid flooring has a Shore “D” hardness reading of 49.6 with a Type “D” Durometer.

### Examples 4a-h

To evaluate the extraction resistance of polyester fiber reinforced PVC floor covering recipes, PVC plastisols are prepared using the recipes given in Tables II and III.

### Plasticizers Evaluated

TOTM—trioctyl trimellitate
PlastHall P-670—polymeric adipate
Paraplex A-8000—polymeric adipate
PlastHall P-650—polymeric adipate
DOA—dioctyl adipate
Palamoll 652—polymeric adipate
Palamoll 654—polymeric adipate
DOP—dioctyl phthalate

TABLE II
PVC Plastisol Compositions for Extraction Testing
Units - PPH - parts per hundred parts PVC

| | | | | | | Heat | Secondary | |
|---|---|---|---|---|---|---|---|---|
| | | | | | | Stabilizer | Heat Stab. | Fiber |
| | Plasticizer | | | | | Mark | Drapex | Polyester |
| Example | TOTM | P-670 | A-8000 | P-650 | DOA | 4878 | 6.8 | ⅛″ cut |
| 4a | 56 | — | — | — | — | 3 | 5 | 22 |
| 4b | 45 | — | — | — | 11 | 3 | 5 | 22 |
| 4c | — | 62 | — | — | — | 3 | 5 | 22 |
| 4d | — | — | 62 | — | — | 3 | 5 | 22 |
| 4e | — | — | — | 62 | — | 3 | 5 | 27 |

TABLE III
PVC Plastisol Recipes for Extraction Testing
Units - PPH - parts per hundred parts PVC

| | | | | Heat | Secondary | |
|---|---|---|---|---|---|---|
| | | | | Stabilizer | HS | Fiber |
| | Plasticizer | | | Mark | Drapex | Polyester |
| Example | 652 | 654 | DOP | 4878 | 6.8 | ⅛″ cut |
| 4f | 62 | — | — | 3 | 5 | 22 |
| 4g | — | 62 | — | 3 | 5 | 22 |
| 4h | — | — | 48 | 3 | 5 | 22 |

### General Procedure for Cooking Oil Extraction Testing

A PVC plastisol is produced by the following procedure. The liquid plasticizer, heat stabilizer, and secondary heat stabilizer/plasticizer are weighed out in grams according to parts given in Tables II and III and blended together. Then 100 grams of dispersion grade of PVC (Geon 173) is dispersed in the liquid plasticizer/heat stabilizer blend by slowly adding the PVC powder to the liquid under agitation. The plastisol produced above is transferred to a dough-kneading mixer and polyester fiber (⅛″ cut length) is added to the liquid plastisol while kneading. This plastisol/fiber mixture produces a dough type material that is used to mold the plaques and films for extraction testing.

A ¼″ thick plaque is molded by pressing the plastisol/fiber dough mixture into a 2.5″×2.5″×¼″ thick plaque mold. The plastisol/fiber mixture is fused in an oven at 175° C. held at that temperature for a one-hour period. The mold is allowed to cool and the plaque is removed from the mold to use for extraction testing. A 0.020″ (20 mil) film is molded from the plastisol/fiber mixture by pressing the mixture between two polished aluminum plates with a spacer to produce a 20 mil film. The aluminum film mold is placed in an oven at 175° C. and held at that temperature for a one-hour period. The molded film is allowed to cool and the 20 mil film obtained is used for extraction testing.

### Cooking Oil Extraction

The 2.5″×2.5″×¼″ thick plaque is cut in quarters that give a total surface area of 4.3 square inches and the 5″×5″×0.020″ film is cut into four 2″×2″ squares giving a 4 square inch surface area (one side) ignoring the 20 mil thickness.

The plaques and films are immersed completely in Crisco® and held at 60° C. for 24 hours. After 24 hours, the plaques are removed and the excess Crisco® is wiped off. The weight of the plaques and films before and after the extraction are measured. The weight loss is attributed to the loss of plasticizer from the plaques or films.

The results of the extraction are given in Table IV.

TABLE IV
Results from Extraction of Plaques in Crisco ® at 60° C.
Plasticizer Loss

| | | | | | | | % Plasticizer | |
|---|---|---|---|---|---|---|---|---|
| | | | Actual Loss (g) | | % Loss Total | | Loss | |
| Example | Plasticizer | PPH | 20 mil | 0.25″ | 20 mil | 0.25″ | 20 mil | 0.25″ |
| 4b | TOTM/DOA | 56 | 0.169 | 0.1678 | 12.37 | 2.19 | 42.15 | 7.28 |
| 4a | TOTM | 56 | 0.1761 | 0.1711 | 12.3 | 2.2 | 36.45 | 5.49 |
| 4i | DOP | 48 | 0.1914 | 0.0656 | 10.78 | 0.84 | 39.98 | 3.13 |
| 4d | A-8000 | 62 | 0.0928 | 0.0482 | 5.64 | 0.64 | 17.46 | 1.98 |
| 4c | P-670 | 62 | 0.0773 | 0.0521 | 5.36 | 0.7 | 16.6 | 2.15 |
| 4f | 652 | 62 | 0.0563 | 0.0486 | 3.85 | 0.63 | 11.93 | 1.94 |
| 4g | 654 | 62 | 0.0488 | −0.0057 | 3.4 | −0.07 | 10.52 | −0.23 |

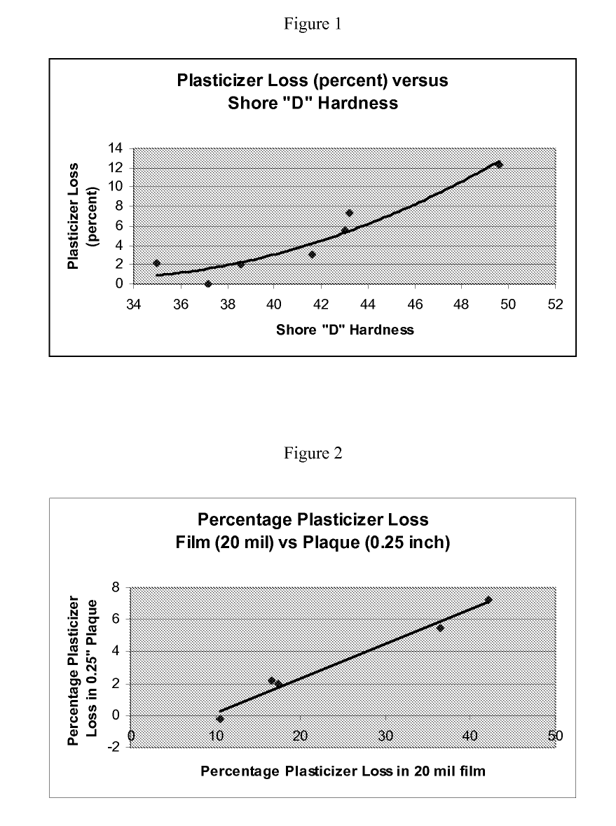

Shore “A” and Shore “D” values for Examples 4a-h before and after extraction testing are given in Table V. FIG. 1 shows the relationship between Shore “D” hardness and loss of plasticizer from 0.25″ thick plaques from Examples 4a-h.

TABLE V
Shore “A” and Shore “D” Before and After Extraction Testing

| | | | Shore “A” Hardness | | Shore “D” Hardness | |
|---|---|---|---|---|---|---|
| | | | Before | | Before | |
| Exam- | | | Extrac- | After | Extrac- | After |
| ple | Plasticizer | PPH | tion | Extraction | tion | Extraction |
| 4b | TOTM/DOA | 56 | 86.4 | >90 | 37.4 | 43.2 |
| 4a | TOTM | 56 | 87 | >90 | 37.6 | |
| 4h | DOP | 48 | 84.8 | 90 | 38.4 | 41.6 |
| 4d | A-8000 | 62 | 84 | 87.4 | 34.8 | 38.6 |
| 4c | P-670 | 62 | 85 | 85.2 | 34.8 | |
| 4f | 652 | 62 | 85.2 | 87 | 37.2 | 37.2 |
| 4g | 654 | 62 | 84.8 | 86.6 | 36.6 | 37.2 |

### Example 5

PVC/polyester fiber dry blend is prepared based on A-8000 polymeric plasticizer. A suspension grade of PVC powder is used to produce the PVC dry blend which is mixed with heat-set polyester ⅛″ cut polyester staple fiber. The suspension grade of PVC absorbs the plasticizer to produce a “dry blend” which appears dry to the touch and has good flow properties for feeding to an extruder. The recipe in Table VI is used to prepare the PVC/fiber dry blend.

TABLE VI
Flexible Polyester Fiber Reinforced PVC Sheet Recipe

| Material | Supplier/Grade | Weight % |
|---|---|---|
| PVC | Oxyvinyl/240F | 51.95 |
| Polymeric plasticizer | C P Hall/A-8000 | 32.21 |
| Epoxidized soybean oil | Chemtura/Drapex 6.8 | 2.57 |
| Heat stabilizer | Chemtura/Mark 4878 | 1.54 |
| Stearic acid | Aldrich | 0.22 |
| Polyester fiber ⅛″ cut | Barnet | 11.50 |

The flexible PVC recipe in Table VI is dry blended at 105° C. and mixed with 11.5% fiber.

Fiber reinforced flexible PVC sheet is produced from the dry PVC dry blend using a 1.5″ Killion single screw extruder. The feed zone is set at 250° F. and the extrusion zones, adapter, and die are set at 350° F. for each type of extruder. The calendaring rolls are heated to 160° F. A through put rate of 38 lbs/hr is achieved with the PVC/fiber dry blend.

### Example 6

Pellets from the dry blend in Table VI are produced using a 21 mm Theysohn twin-screw extruder adapted with a single hole strand die. The pellets are collected and dried for use in the 1.5 inch Killion single screw extruder adapted to the sheet die and using the same extruder setting as in Example 5. Reinforced, flexible PVC sheet is produced at a rate of 58 lbs/hr. The thickness of this sheet is 81 mils. The Shore “A” hardness for this sheet is 83.

### Example 7

The 1.25″×1.25″ square plaque of the extruded sheet from Example 6 is extracted with Crisco® using the extraction method described herein. This plaque is compared to a plaque with a similar composition produced by a plastisol process, Example 4d. The extraction results are given in Table VII. The Shore “A” hardness after extraction testing of this plaque is 86.

TABLE VII
Extraction Results Comparing Flexible PVC Produced by
Plastisol Process with a Dry Blend/Extrusion Process

| Material | Extraction (grams/sq. in.) |
|---|---|
| Extruded Sheet from | 0.0129 |
| Example 6 | |
| Plastisol Plaque from | 0.0134 |
| Example 4d | |

### Example 8

Thin strips of the 20 mil films (⅛ inch×2 inches) are extracted with Crisco® cooking oil by the accelerated extraction method described herein and the percentage linear shrinkage is calculated from the change in length. The percent linear shrinkage is given in Table VIII.

TABLE VIII
Percentage Linear Shrinkage for Polymeric
and Monomeric Plasticized Films

| Material | % Shrinkage | % Plasticizer Loss |
|---|---|---|
| PVC plasticized with | −2.6 | 42.15 |
| TOTM/DOA from Example | | |
| 4b | | |
| PVC plasticized with | −3.8 | 36.45 |
| TOTM from Example 4a | | |
| PVC plasticized with DOP | −2.5 | 39.98 |
| from Example 4h | | |
| PVC plasticized with | −1.2 | 17.46 |
| A-8000 from Example 4d | | |
| PVC plasticized with P-670 | 0 | 16.6 |
| from Example 4c | | |
| PVC plasticized with 652 | 0 | 11.93 |
| from Example 4f | | |
| PVC plasticized with 654 | 0 | 10.52 |
| from Example 4g | | |

### Examples 9a-d

Fiber reinforced, flexible PVC plaques (0.25″) and films (20 mils) are produced from a plastisol containing 100 parts of PVC, 58 parts of plasticizer per hundred parts of PVC (PPH), 5 PPH of epoxidized soybean oil, Drapex® 6.8, and 3 PPH of Mark 4878 mixed metal heat stabilizer. Mixtures of monomeric and plasticizers, DOA and TOTM, with the polymeric plasticizer Palamoll® 654 in the ratios given in Table IX, Examples 9b, 9c, and 9d are used and compared to 100 percent Palamoll® 654 in Table IX, Example 9a. Examples 9a-d contains 11.5 weight percent heat set staple polyester fiber with ⅛ inch cut length. These films and plaques are extracted with Crisco® cooking oil using the extraction test method described herein.

TABLE IX
Extraction Testing on Polymeric and Monomeric Blends

| | | % Plasticizer | % Plasticizer | |
|---|---|---|---|---|
| | | Loss | Loss | Shore “A” |
| | | 0.25″ Plaque | 20 mil Film | Hardness after |
| Example | Material | after 24 hrs | after 24 hrs | extraction |
| 9a | 654 | 1.29% | 10.76% | 87.4 |
| | (100) | | | |
| 9b | 654/TOTM | −0.28% | 7.41% | 86.4 |
| | (90/10) | | | |
| 9c | 654/DOA | 2.55% | 17.78% | 85.4 |
| | (75/25) | | | |
| 9d | 654/TOTM | 0.39% | 4.88% | 84.6 |
| | (45/55) | | | |

FIG. 2 is a graph illustrating the linear relationship between plasticizer losses for 0.25″ plaque and 20 mil films. Based on the accelerated cooking oil extraction testing describe herein, a 0.25 inch plaque should not lose more that 3.5 percent of its primary plasticizer content, or a 20 mil film should not lose more than 25 percent of its plasticizer content. The linear relationship between plasticizer losses for 0.25″ plaque and 20 mil films is evident in FIG. 2. Accordingly, plasticizer losses for the plaque or film are correlated and both of these extraction percentages define acceptable losses for fiber reinforced flexible PVC compositions.

Example 7 shows that the cooking oil extraction resistance is independent of the production process. Either a plastisol or a dry blend process can be used to produce reinforced flexible PVC flooring that is resistant to extraction by cooking oil and grease. An exemplary production method is PVC dry blend process followed by extrusion.

Minimization of the shrinkage can be important for long term stability of the flooring and to prevent cracking, weld failure, de-bonding or warping of the flooring resulting in a reduction of the sanitary performance of the flooring and creating potential trip hazards. No shrinkage (zero shrinkage) would give the best possible performance but minimization of the shrinkage can be advantageous. The results in Example 8 show that reinforced, flexible PVC sheet produced from compositions in which the plasticizer in a 20 mil film is about 25 percent or less extractable by the accelerated extraction method described herein. This level of extraction also sets the extractable level of a 0.25 inch thick sheet at 3.5 percent or less due the correlation, FIG. 2, established from Examples 4a-h.

Example 9 shows that up to about 55 percent of the low extractable polymeric plasticizer can be replaced with monomeric plasticizer which has been shown here to be highly extractable and still maintain the desirable extraction performance of a reinforced, flexible PVC for flooring applications. The use of monomeric plasticizers as part of the flooring composition can allow greater flexibility in the use of recycled PVC, for example, flexible recycled PVC in these flooring compositions. The use of recycled PVC can be beneficial in the lessening of the environmental impact of waste PVC and reduction of cost for production of the reinforced flexible PVC flooring.

The present invention can accordingly provide a reinforced, flexible PVC flooring sheet that can be welded to produce a seamless safety and sanitary surface that can have excellent resistance to extraction by hydrocarbon solvents and extractants and floor cleaners. Exemplary flooring sheets can include:

100 parts of PVC with inherent viscosities measured by ASTM-D-1243-60-A ranging from about 0.63 to about 1.60 dl/g, or more, for example, about 0.78 to about 1.40 dl/g, or for example about 0.83 to about 1.40 dl/g;

about 40 to about 62 parts of a primary plasticizer per 100 parts of PVC (PPH), for example about 48 to about 62 PPH of plasticizer, or for example about 48 to about 58 PPH; where the primary plasticizer can be a polymeric plasticizer or a mixture of polymeric plasticizers and monomeric plasticizers; where the primary plasticizer in total or in part can be incorporated into the composition through a recycled PVC material, or for example, a recycled flexible PVC material.

The primary plasticizer can include between about 45 to about 100 percent polymeric plasticizer, for example, between about 45 to about 70 percent polymeric plasticizer. Monomeric plasticizers can comprise the remaining about 30 to about 55 percent of primary plasticizer.

The composition can further include:

about 3 to about 5 PPH of a secondary heat stabilizer/plasticizer such as epoxidized soybean oil;

about 1 to about 5 PPH of a mixed metal stabilizer for PVC such as barium zinc mixed metal stabilizer; and

about 1 to about 30 PPH of filler or pigment or combinations of the two.

The PVC flooring composition can contain additives such as mildewcides, UV and light stabilizers, antioxidants, flame retardants and other additives, as well as combinations thereof.

The PVC flooring can be reinforced with fiber such as polyester, nylon, cellulose based fibers, natural fibers, fiberglass, carbon fiber, mineral fibers such as Wollastanite, and other reinforcing fibers. Mixtures of these fibers can also be useful. The fiber length can range from about ⅛ to about ½ of an inch. The fiber can comprise about 10 to about 30 percent of the PVC floor composition. Exemplary fibers can include heat set polyester staple fiber, nylon 6 fiber, and nylon 66 fiber. Heat set staple polyester fibers with dpf, denier per fiber, in the range of about 0.5 to about 13 can be useful, as well as heat set staple polyester fibers with a dpf of about 3 to about 6. Nylon 6 fibers with a dpf of about 3 to about 6 and Nylon 66 fibers with a dpf of about 1 to about 22 can also be useful.

The portion of reinforced flexible PVC sheet that is not from a recycle stream can be produced though dry blend compounding of a sorptive suspension grade PVC powder, plasticizer, additives, filler, fiber, and the like, followed by addition of any recycle PVC stream and melt blending in an extruder adapted with a sheet die and calendaring equipment. The sheet thickness can be about one-eighth to about one-quarter inch. Methods other than the dry blend/extrusion process can also be useful in the sheet production of this reinforced, flexible PVC sheet.

In exemplary embodiments of the invention, based on the accelerated cooking oil extraction testing described herein, a 0.25 inch plaque comprised of the above compositions may not lose more that about 3.5 percent of its primary plasticizer content, or a 20 mil film may not lose more than about 25 percent of its plasticizer content; and 0.25 inch plaque can maintain a Shore “A” hardness of not greater than 90 durometer reading on a Type “A” Durometer or a Shore “D” hardness of not greater than 41 durometer reading on a Type “D” Durometer by ASTM D2240.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A polymeric composition useful in the production of sanitary non-skid flooring, comprising:
polyvinyl chloride (PVC);
fibrous material; and
a primary plasticizer component comprising a low extractable plasticizer.

2. The polymeric composition of claim 1, wherein said low extractable plasticizer comprises a polymeric plasticizer.

3. The polymeric composition of claim 2, wherein said polymeric plasticizer is derived from one or more multi-functional acids and one or more alcohols with a molecular weight ranging from about 500 to about 7000 Daltons.

4. The polymeric composition of claim 3, wherein said one or more multi-functional acids comprises an acid selected from the group consisting of adipic acid, glutaric acid, sebacic acid, azelaic acid, and combinations thereof.

5. The polymeric composition of claim 4, wherein said polymeric plasticizer comprises polymeric adipate.

6. The polymeric composition of claim 1, wherein said low extractable plasticizer comprises a monomeric plasticizer capable of strong solvation in PVC.

7. The polymeric composition of claim 6, wherein monomeric plasticizer capable of strong solvation in PVC comprises butyl benzyl phthalate.

8. The polymeric composition of claim 1, wherein said primary plasticizer component comprises said low extractable plasticizer in an amount sufficient to substantially minimize hydrocarbon extraction of said primary plasticizer component from a sheet material formed of said composition.

9. The polymeric composition of claim 1, wherein said primary plasticizer component comprises at least about 45 percent of said low extractable plasticizer.

10. The polymeric composition of claim 9, wherein said primary plasticizer component comprises about 45 percent to about 100 percent of said low extractable plasticizer.

11. The polymeric composition of claim 10, wherein said primary plasticizer component comprises about 45 percent to about 70 percent of said low extractable plasticizer.

12. The polymeric composition of claim 11, wherein said primary plasticizer component further comprises a highly extractable plasticizer.

13. The polymeric composition of claim 12, wherein said highly extractable plasticizer comprises a monomeric plasticizer.

14. The polymeric composition of claim 13, wherein said monomeric plasticizer comprises a mono-, di-, or tri-ester of a mono-, di-, or tri-carboxylic acid and phosphoric acid.

15. The polymeric composition of claim 13, wherein said monomeric plasticizer comprises a plasticizer selected from the group consisting of dioctyl phthalate, dioctyl adipate, trioctyl trimellitate, and combinations thereof.

16. The polymeric composition of claim 9, comprising about 40 to about 62 parts of said primary plasticizer component per 100 parts PVC.

17. The polymeric composition of claim 1, wherein said PVC comprises PVC homopolymer, PVC copolymer or a combination thereof.

18. The polymeric composition of claim 17, wherein said PVC has an inherent viscosity ranging from about 0.63 to about 1.60 dl/g, as measured by ASTM-D-1243-60-A.

19. The polymeric composition of claim 1, wherein said PVC comprises recycled PVC.

20. The polymeric composition of claim 1, wherein said PVC comprises virgin PVC.

21. The polymeric composition of claim 1, wherein said PVC comprises virgin PVC and recycled PVC.

22. The polymeric composition of claim 1, wherein said fibrous material comprises polyester fibrous material, polyolefin fibrous material, polyamide fibrous material, cellulose based fibrous material, natural fibrous material, fiberglass, carbon fibrous material, mineral fibrous material, and combinations thereof.

23. The polymeric composition of claim 22, wherein said fibrous material comprises staple fibers.

24. The polymeric composition of claim 23, wherein said fibrous material comprises polyester staple fibers.

25. The polymeric composition of claim 24, wherein said fibrous material comprises polyester staple fibers having a denier per fiber (dpf) of about 0.5 to about 13 and a cut length of about ⅛ to about ½ inch.

26. The polymeric composition of claim 1, comprising about 10 to about 25 percent by weight of said fibrous material.

27. A floor covering on a floor, said floor covering comprising a sheet of polymer material comprising polyvinyl chloride; fibrous material; and a primary plasticizer component comprising a low extractable plasticizer in an amount sufficient to substantially minimize hydrocarbon extraction of said primary plasticizer component from said floor covering.

28. The floor covering of claim 27, having a thickness of about ⅛ to about ¼ inch.

29. The floor covering of claim 27, wherein said floor covering is about ¼ inch thick and has a hydrocarbon extractability of said primary plasticizer component of less than about 3.5 percent.

30. The floor covering of claim 29, having a Shore A hardness of less than about 90, as measured by ASTM D2240.

31. The floor covering of claim 29, having a Shore D hardness of less than about 41, as measured by ASTM D2240.

32. The floor covering of claim 27, wherein said low extractable plasticizer comprises a polymeric plasticizer.

33. The floor covering of claim 32, wherein said polymeric plasticizer is derived from one or more multi-functional acids selected from the group consisting of adipic acid, glutaric acid, sebacic acid, azelaic acid, and combinations thereof.

34. The floor covering of claim 33, wherein said polymeric plasticizer comprises polymeric adipate.

35. The floor covering of claim 27, wherein said low extractable plasticizer comprises a monomeric plasticizer capable of strong solvation in PVC.

36. The floor covering of claim 35, wherein monomeric plasticizer capable of strong solvation in PVC comprises butyl benzyl phthalate.

37. The floor covering of claim 27, wherein said primary plasticizer component comprises at least about 45 percent of said low extractable plasticizer.

38. The floor covering of claim 37, wherein said primary plasticizer component comprises about 45 percent to about 100 percent of said low extractable plasticizer.

39. The floor covering of claim 38, wherein said primary plasticizer component comprises about 45 percent to about 70 percent of said low extractable plasticizer.

40. The floor covering of claim 39, wherein said primary plasticizer component further comprises a highly extractable plasticizer.

41. The floor covering of claim 37, comprising about 40 to about 62 parts of said primary plasticizer component per 100 parts PVC.

42. The floor covering of claim 27, wherein said PVC comprises PVC homopolymer, PVC copolymer or a combination thereof.

43. The floor covering of claim 27, wherein said PVC comprises recycled PVC.

44. The floor covering of claim 27, wherein said PVC comprises virgin PVC.

45. The floor covering of claim 27, wherein said PVC comprises virgin PVC and recycled PVC.

46. The floor covering of claim 27, wherein said fibrous material comprises polyester fibrous material, polyolefin fibrous material, polyamide fibrous material, cellulose based fibrous material, natural fibrous material, fiberglass, carbon fibrous material, mineral fibrous material, and combinations thereof.

47. The floor covering of claim 46, wherein said fibrous material comprises staple fibers.

48. The floor covering of claim 47, wherein said fibrous material comprises polyester staple fibers.

49. The floor covering of claim 48, wherein said fibrous material comprises polyester staple fibers having a denier per fiber (dpf) of about 0.5 to about 13 and a cut length of about ⅛ to about ½ inch.

50. The floor covering of claim 27, comprising about 10 to about 25 percent by weight of said fibrous material.

51. A flooring element comprising:
a generally rectangular three-dimensional solid polymer in a thickness of about ⅛ to about ¼ inch, a width of at least about four feet and a length of at least about six feet comprising polyvinyl chloride; fibrous material; and a primary plasticizer component comprising a low extractable plasticizer in an amount sufficient to substantially minimize hydrocarbon extraction of said primary plasticizer component from said flooring element.

52. The flooring element of claim 51, wherein said flooring element is about ¼ inch thick and has a hydrocarbon extractability of said primary plasticizer component of less than about 3.5 percent.

53. The flooring element of claim 52, having a Shore A hardness of less than about 90, as measured by ASTM D2240.

54. The flooring element of claim 52, having a Shore D hardness of less than about 41, as measured by ASTM D2240.

55. The flooring element of claim 51, wherein said low extractable plasticizer comprises a polymeric plasticizer.

56. The flooring element of claim 51, wherein said low extractable plasticizer comprises a monomeric plasticizer capable of strong solvation in PVC.

57. The flooring element of claim 51, wherein said primary plasticizer component comprises at least about 45 percent of said low extractable plasticizer.

58. The flooring element of claim 57, wherein said primary plasticizer component comprises about 45 percent to about 100 percent of said low extractable plasticizer.

59. The flooring element of claim 58, wherein said primary plasticizer component comprises about 45 percent to about 70 percent of said low extractable plasticizer.

60. The flooring element of claim 59, wherein said primary plasticizer component further comprises a high extractable plasticizer.

61. The flooring element of claim 57, comprising about 40 to about 62 parts of said primary plasticizer component per 100 parts PVC.

62. A method of making a polymeric sheet material useful for the production of sanitary non-skid flooring, comprising:
mixing polyvinyl chloride (PVC), fibrous material, and a primary plasticizer component to form a PVC composition, wherein said primary plasticizer component comprises a low extractable plasticizer in an amount sufficient to substantially minimize hydrocarbon extraction of said primary plasticizer component from a sheet material formed of said composition; and
forming a sheet material having a thickness of about ⅛ to about ¼ inch from said composition.

63. The method of claim 62, wherein said forming step comprises forming a sheet material about ¼ inch thick having a hydrocarbon extractability of said primary plasticizer component of less than about 3.5 percent.

64. The method of claim 62, wherein said PVC comprises virgin PVC.

65. The method of claim 62, wherein said PVC comprises recycled PVC.

66. The method of claim 65, wherein said recycled PVC comprises recycled PVC roofing material.

67. The method of claim 62, wherein said PVC comprises virgin PVC and recycled PVC.

68. The method of claim 62, wherein said mixing step comprises dispersing PVC in a liquid plasticizer component to form a plastisol and thereafter mixing said fibrous material in said plastisol and wherein said forming step comprising molding said plastisol to form said sheet material.

69. The method of claim 62, wherein said mixing step comprises dry blending said PVC, fibrous material and primary plasticizer component and wherein said forming step comprises melt extruding said dry blend.

70. The method of claim 69, further comprising melt blending recycled PVC with said dry blend prior to said melt extrusion step.

71. The method of claim 69, further comprising the step of pelletizing said dry blend to form pellets prior to said melt extruding step.

72. The method of claim 71, further comprising melt blending recycled PVC with said pellets prior to said melt extrusion step.

73. The method of claim 62, wherein said low extractable plasticizer comprises a polymeric plasticizer.

74. The method of claim 62, wherein said low extractable plasticizer comprises a monomeric plasticizer capable of strong solvation in PVC.

75. The method of claim 62, wherein said primary plasticizer component comprises at least about 45 percent of said low extractable plasticizer.

76. The method of claim 75, wherein said primary plasticizer component comprises about 45 percent to about 100 percent of said low extractable plasticizer.

77. The method of claim 76, wherein said primary plasticizer component comprises about 45 percent to about 70 percent of said low extractable plasticizer.

78. The method of claim 77, wherein said primary plasticizer component further comprises a high extractable plasticizer.

79. The method of claim 62, wherein said mixing step comprises mixing about 40 to about 62 parts of said primary plasticizer component per 100 parts PVC.

80. The method of claim 62, wherein said fibrous material comprises polyester fibrous material, polyolefin fibrous material, polyamide fibrous material, cellulose based fibrous material, natural fibrous material, fiberglass, carbon fibrous material, mineral fibrous material, and combinations thereof.

81. The method of claim 80, wherein said fibrous material comprises staple fibers.

82. The method of claim 81, wherein said fibrous material comprises polyester staple fibers.

83. The method of claim 82, wherein said fibrous material comprises polyester staple fibers having a denier per fiber (dpf) of about 0.5 to about 13 and a cut length of about ⅛ to about ½ inch.

84. The method of claim 62, further comprising the step of installing said sheet material on a floor.
